(19) United States
(12) Patent Application Publication
(10) Pub. No.: US 2008/0174800 A1
(43) Pub. Date: Jul. 24, 2008

(54) IMAGE FORMING APPARATUS, PRINTING SYSTEM INCLUDING THE SAME AND CONTROL METHOD THEREOF

(75) Inventors: Hyun Chul KIM, Suwon-si (KR); Jong Kwon Park, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/015,009

(22) Filed: Jan. 16, 2008

(30) Foreign Application Priority Data
Jan. 19, 2007 (KR) 2007-6124
Dec. 18, 2007 (KR) 2007-133544

(51) Int. Cl. G06K 1/00

(52) U.S. Cl. 358/1.9; 358/1.15

(57) ABSTRACT

An image forming apparatus capable of satisfying various desires of a user by providing the user with psychological stability, a printing system including the same, and a method of controlling the image forming apparatus and the printing system. The method of controlling the image forming apparatus includes detecting characteristic information of print data, and reproducing multimedia content corresponding to the characteristic information of the print data during a printing process of the print data.

### CROSS-REFERENCE TO RELATED APPLICATIONS

This application claims priority under 35 U.S.C. §119(a) from Korean Patent Application No. 2007-6124, filed on Jan. 19, 2007, and Korean Patent Application No. 2007-133544, filed on Dec. 18, 2007 in the Korean Intellectual Property Office, the disclosure of which is incorporated herein in its entirety by reference.

### BACKGROUND OF THE INVENTION

1. Field of the Invention

The present general inventive concept relates to an image forming apparatus, a printing system including the same, and a method of controlling the image forming apparatus and the printing system. More particularly, the present general inventive concept relates to an image forming apparatus, a printing system including the same, and a method of controlling the image forming apparatus and the printing system, which detect characteristic information of print data reproduce music and images based on the characteristic information of the print data during a printing process of the print data.

2. Description of the Related Art

Recently, peripheral devices of a computer, such as image forming apparatuses, printers, scanners, photocopiers, facsimiles or multifunctional devices, are extensively used to enable users to utilize computers in various ways.

Accordingly, various technologies have been developed for convenience. One of them is an image forming device capable of sounding an alarm according to an operational state thereof.

The above image forming apparatus sounds alarms having different patterns according to a printing state, an error state and a waiting state, so that the user can recognize the operational state of the image forming apparatus.

However, although the image forming apparatus which sounds alarms corresponding to various operational states can improve user convenience, the image forming apparatus has only a printing function, so the demand for a new image forming apparatus capable of satisfying the sensitivity of the user is increasing more and more.

In addition, due to electronic noise and cold images generated from the alarms of the image forming apparatus, the image forming apparatus may increase psychological instability of the user.

### SUMMARY OF THE INVENTION

The present general inventive concept provides an image forming apparatus, a printing system including the same, and a method of controlling the image forming apparatus and the printing system, which output music and images based on characteristic information of print data during an image forming process.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a method of controlling an image forming apparatus, which includes the steps of detecting characteristic information of print data, and reproducing multimedia content corresponding to the characteristic information of the print data during a printing process of the print data.

The print data may be analyzed to determine if the print data is text data or image data.

Detecting the characteristic information may include detecting the characteristic information of the print data using words of the print data if the print data is the text data, and detecting the characteristic information of the print data using colors of the print data if the print data is the image data.

The method may further include determining if reference characteristic information corresponding to the characteristic information of the print data is stored.

During the reproducing of the multimedia content, if the reference characteristic information corresponding to the characteristic information of the print data is stored, multimedia content corresponding to the reference characteristic information is reproduced during the printing process of the print data.

The method may further include of displaying a reproduction message to reproduce the multimedia content, which corresponds to the reference characteristic information, on a predetermined screen display device if the reference characteristic information corresponding to the characteristic information of the print data is stored.

The method may further include displaying a message, which represents that the multimedia content cannot be reproduced, on a predetermined screen display device if the reference characteristic information corresponding to the characteristic information of the print data is not stored.

If the reference characteristic information corresponding to the characteristic information of the print data is not stored, the reference characteristic information and the multimedia content corresponding to the reference characteristic information may be searched and stored.

The multimedia content may searched after accessing a server connected to the image forming apparatus, and may be stored as the multimedia content corresponding to the reference characteristic information.

The method may further include receiving a selection command to reproduce the multimedia content, and the multimedia content corresponding to the characteristic information of the print data is reproduced during the printing process of the print data if the selection command for reproducing the multimedia content is received.

The multimedia content may include at least one of sound, an image and text data.

The foregoing and/or other aspects and utilities of the present general inventive concept can also be achieved by providing an image forming apparatus, including a control unit to detect characteristic information of print data, a printing unit to print the print data, an image output unit to output an image, and an audio output unit to output sound, wherein the control unit outputs an image or sound corresponding to the characteristic information of the print data during a printing process of the print data.

The image forming apparatus may further include an input unit to receive a selection command to reproduce the image or sound.

The image forming apparatus may further include a storage unit to store an image or sound corresponding to reference characteristic information.

The foregoing and/or other aspects and utilities of the present general inventive concept can also be achieved by providing a printing system including a terminal apparatus provided with a printer driver to detect characteristic information of print data from words or colors of the print data, and an image forming apparatus connected to the terminal apparatus through a network and storing at least one multimedia content corresponding to characteristic information of at least one print data, wherein the image forming apparatus reproduces multimedia content corresponding to the characteristic information of the print data, which is transmitted from the terminal apparatus, during a printing process of the print data.

The printer driver may determine if the print data is text data or image data by analyzing the print data.

The foregoing and/or other aspects and utilities of the present general inventive concept can also be achieved by providing an image forming apparatus, including a printing unit to print data onto a printing medium, a storage unit to store multimedia content corresponding to at least one reference characteristic information, an image output unit to selectively output an image corresponding to the multimedia content, and an audio output unit to selectively output an image corresponding to the multimedia content.

The image output unit may output at least one image when the printing unit prints the data onto the printing medium.

The audio output unit may output at least one sound when the printing unit prints the data onto the printing medium.

The image output unit may display a reproduction message to reproduce multimedia content corresponding to the reference characteristic information when the reference characteristic information is stored.

The image forming apparatus may further include an input unit to allow a user to input the reference characteristic information, and a server to access a web-site to store in the storage unit the multimedia content corresponding to the at least one characteristic information when the reference characteristic information is input by a user.

The reference characteristic information may be information corresponding to human emotions.

The multimedia content may be labeled as a sound or an image corresponding to the reference characteristic information.

The foregoing and/or other aspects and utilities of the present general inventive concept can also be achieved by providing a method of controlling an image forming apparatus, including printing data onto a printing medium, storing multimedia content corresponding to at least one reference characteristic information, selectively outputting an image corresponding to the multimedia content, and selectively outputting an image corresponding to the multimedia content.

The method may further include accessing a web-site to store in the storage unit the multimedia content corresponding to the at least one characteristic information when the reference characteristic information is input by a user.

### BRIEF DESCRIPTION OF THE DRAWINGS

These and/or other aspects and utilities of the general inventive concept will become apparent and more readily appreciated from the following description of the embodiments, taken in conjunction with the accompanying drawings of which:

FIG. 1 is a block diagram illustrating an image forming apparatus according to an embodiment of the present general inventive concept;

FIG. 2 is a block diagram illustrating a printing system according to another embodiment of the present general inventive concept;

FIG. 3 is a flowchart illustrating a process of controlling an image forming apparatus according to an embodiment of the present general inventive concept and a process of controlling a printing system according to another embodiment of the present general inventive concept;

FIG. 4A is a view illustrating a multimedia content reproduction message used to select reproduction of music according to an embodiment of the present general inventive concept;

FIG. 4B is a view illustrating a multimedia content reproduction message used to select reproduction of an image according to an embodiment of the present general inventive concept; and

FIG. 5 is a view illustrating the message, which represents that multimedia content cannot be reproduced, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

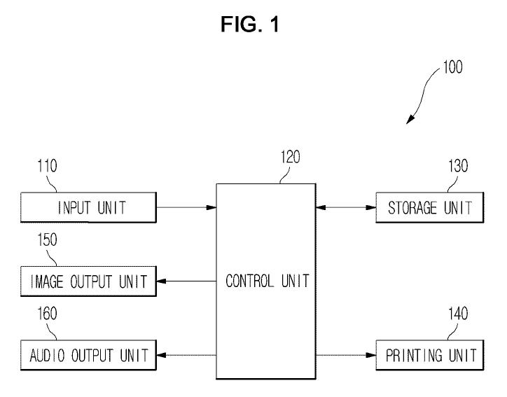

FIG. 1 is a block diagram illustrating an image forming apparatus according to an embodiment of the present general inventive concept. The image forming apparatus 100 includes an input unit 110, a control unit 120, a storage unit 130, a printing unit 140, an image output unit 150 and an audio output unit 160.

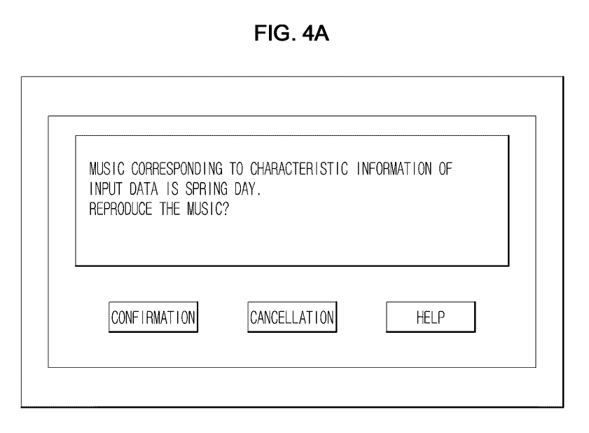

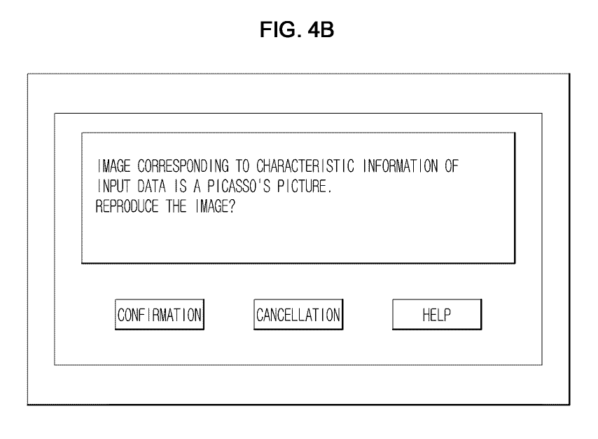

The input unit 110 receives a print mode (normal mode or power saving mode), and a control command including a menu, scanning, discharging/selection, etc. Further, when a user wants to reproduce multimedia content based on characteristic information of print data during a printing process of the print data in response to a message displayed on the image output unit 150 as illustrated in FIG. 4A, the input unit 110 receives a selection command such as “confirmation.” In addition, when the user wants to print only the print data without reproducing the multimedia content, the input unit 110 receives a selection command such as “cancellation.” The input unit 110 can be a keyboard, a touch screen, a trackball, a keypad, or any other type of input device.

The control unit 120 determines a type of the print data by analyzing the print data. That is, the control unit 120 determines if the print data is text data including characters, or image data including images.

Further, the control unit 120 detects the characteristic information of the print data. The term “characteristic information” signifies contents of the print data, that is, information representing the type and the characteristics or properties of the print data.

In more detail, if the print data is text data, the control unit 120 detects words related to emotion by searching to find words of the text data, classifying the detected words according to the type of the emotion, and determining the priority of the words according to the number of the classified words. Then, the control unit 120 determines the emotion related to a word having the highest priority as characteristic information of the print data.

For example, if the print data contains a group of words related to emotion ,including “happy,” “sad,” “joy,” “depression,” “nice,” etc the control unit 120 classifies the words into positive words (happy, joy and nice) and negative words (sad and depression), and detects the characteristic information (e.g., pleasant) of the print data based on the words having a higher priority, i.e. the positive words (happy, joy and nice), which are a majority of the words in the group of words. Accordingly, the words having a higher priority are detected by the control unit 120.

Further, if the print data is image data, the control unit 120 detects colors from the image data, classifies the image data according to a type of color, and determines the priority according to a percentage of classified colors. Then, the control unit 120 determines the emotion related to a color having the highest priority as characteristic information of the print data.

For example, if one page of the print data includes percentages of yellow at 50%, red at 30% and blue at 10%, the control unit 120 determines emotion related to the yellow having the highest priority as characteristic information of the print data. Accordingly, emotions related to the colors can be determined depending on a user's preference. For example, a user can determine the color of red to represent the emotion of “anger,” and of the color of blue to represent the emotion of “pleasant.”

In the embodiment of FIG. 1, the characteristic information is detected using words and colors related to emotion. However, the characteristic information may be detected based on various criteria depending on the user's preference.

The control unit 120 determines if reference characteristic information corresponding to the characteristic information of the print data is stored. If the reference characteristic information is stored, the control unit 120 reproduces multimedia content corresponding to the reference characteristic information during a printing process of the print data.

The storage unit 130 stores multimedia content corresponding to characteristic information of at least one print data. The multimedia content may include sound, images and text data. The sound may include music, and the images may include dynamic images, such as video, and pictures.

Further, the storage unit 130 may be a DRAM, an SDRAM, an RDRAM, a DDRAM or an SRAM, which enables input and output of information, and is provided in the image forming apparatus 100.

The printing unit140 prints the print data on a paper. Substantially, the printing unit 140 denotes mechanical elements which perform the printing of the print data. For example, the printing unit 140 can be a laser printer and may include a photoconductive drum, a charging unit, an LSU (laser scanning unit), a transfer unit, a developing unit, a paper feeding unit, and a paper discharge unit.

The image output unit 150 displays various information and images and may be an LCD, a PDP, a TFT, an organic EL (electroluminescence), a CRT, etc. Further, the image output unit 150 may be provided in the image forming apparatus 100 or may also include display devices of other apparatuses connected to the image forming apparatus 100.

The audio output unit 160 denotes a device (e.g., a speaker) capable of outputting sound. When multimedia content includes music, the music is output through the audio output unit 160.

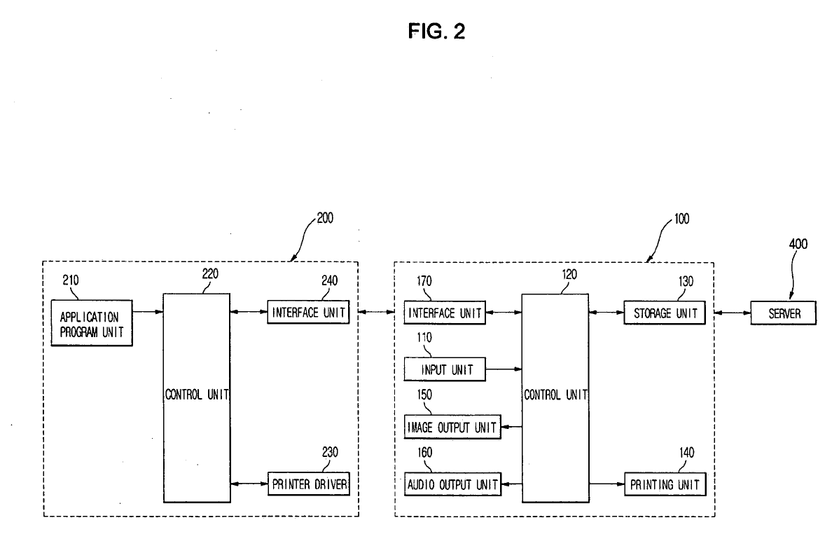

FIG. 2 is a block diagram illustrating a printing system according to another embodiment of the present general inventive concept. The printing system includes a terminal apparatus 200 and the image forming apparatus 100.

The terminal apparatus 200 includes an application program unit 210, a control unit 220, a printer driver 230 and an interface unit 240.

A user may create a document using the application program unit 210 provided in the terminal apparatus 200, view the created document, or input a print command. The terminal apparatus 200 may be various electronic products such as PCs, notebooks or PDAs. In the case of a PC, various word programs may be included in the application program unit 210.

The control unit 220 controls the operation of the terminal apparatus 200 and transmits characteristic information of print data detected by the printer driver 230 to the image forming apparatus 100.

The printer driver 230 determines the type of the print data by analyzing the print data. That is, the printer driver 230 determines if the print data is text data including characters or image data including images.

Further, the printer driver 230 detects the characteristic information of the print data. The characteristic information signifies contents of the print data, that is, information representing the type and characteristics or properties of the print data.

In more detail, if the print data are text data, the printer driver 230 detects words related to emotion by searching to find words of the text data, classifies the detected words according to the type of the emotion, and determines the priority of the words according to the number of the classified words. Then, the printer driver 230 determines emotion related to a word having the highest priority as characteristic information of the print data.

Further, if the print data is image data, the printer driver 230 detects colors from the image data, classifies the image data according to the type of the colors, and determines the priority of the image data according to the percentage of the classified colors. Then, the printer driver 230 determines the emotion related to the color having the highest priority to be the characteristic information of the print data.

The interface unit 240 exchanges data with the image forming apparatus 100. In detail, the interface unit 240 receives the characteristic information of the print data from the control unit 220 and transmits the received characteristic information to the image forming apparatus 100.

The image forming apparatus 100 is connected to the terminal apparatus 200 through a network, and includes the input unit 110, the control unit 120, the storage unit 130, the printing unit140, the image output unit 150, the audio output unit 160 and an interface unit 170.

The input unit 110 receives a print mode (normal mode or power saving mode), and a control command including a menu, scanning, discharging/selection, etc. Further, when a user wants to reproduce multimedia content based on characteristic information of print data during a printing process of the print data in response to the message displayed on the image output unit 150, as illustrated in FIG. 4A, the input unit 110 receives a selection command such as “confirmation.” In addition, when the user wants to print only the print data without reproducing multimedia content, the input unit 110 receives a selection command such as “cancellation.” The input unit 110 can be a keyboard, a touch screen, a trackball, a keypad, etc.

The control unit 120 determines if reference characteristic information corresponding to the characteristic information of the print data is stored. If the reference characteristic information is stored, the control unit 120 reproduces multimedia content corresponding to the reference characteristic information during a printing process of the print data.

The storage unit 130 stores at least one multimedia content corresponding to characteristic information of at least one print data. The storage unit 130 may be a module such as a DRAM, an SDRAM, an RDRAM, a DDRAM or an SRAM, which enables input and output of information, and is provided in the image forming apparatus 100.

The printing unit 140 prints the print data on a sheet of paper. Substantially, the printing unit 140 denotes mechanical elements which perform the printing of the print data. For example, the printing unit 140 can be a laser printer and may include a photoconductive drum, a charging unit, an LSU, a transfer unit, a developing unit, a paper feeding unit, and a paper discharge unit.

The image output unit 150 displays various information and images and may be an LCD, a PDP, a TFT, an organic EL, a CRT, etc. Further, the image output unit 150 may be provided in the image forming apparatus 100 or may also include display devices of other apparatuses connected to the image forming apparatus 100.

The audio output unit 160 denotes a device (e.g., a speaker) capable of outputting music. When multimedia content includes music, the music is output through the audio output unit 160.

The interface unit 170 denotes a path corresponding to data transfer with the terminal apparatus 200. In detail, the interface unit 170 receives the characteristic information of the print data from the terminal apparatus 200.

Hereinafter, operation processes and effects of the image forming apparatus, the printing system including the same, and the method of controlling the image forming apparatus and the printing system will be described.

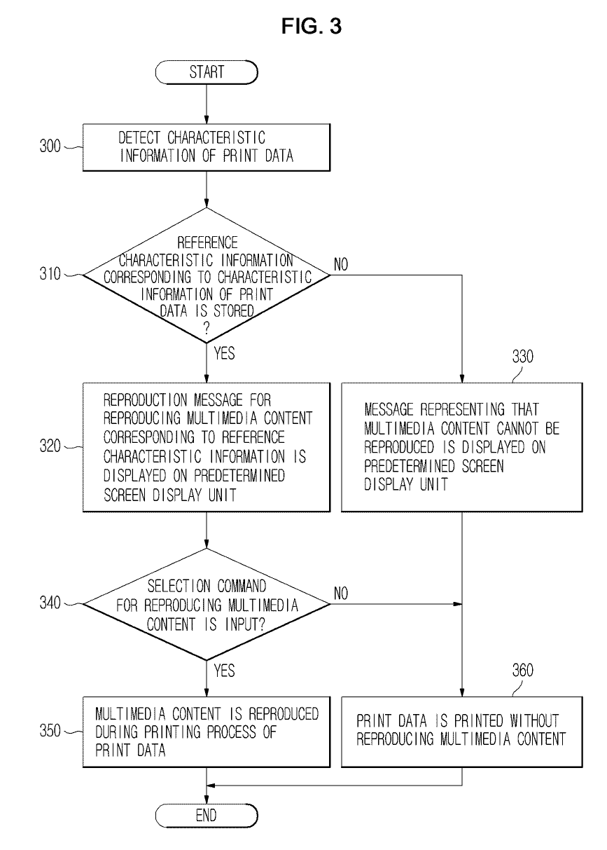

FIG. 3 is a flowchart illustrating a process of controlling the image forming apparatus according to the embodiment of FIG. 1 of the present general inventive concept and a process of controlling the printing system according to the embodiment of FIG. 2 of the present general inventive concept.

Hereinafter, the process of controlling the image forming apparatus according to the embodiment of FIG. 1 of the present general inventive concept will be described with reference to FIG. 3. In operation 300, the image forming apparatus 100 detects characteristic information of print data.

Accordingly, whether the print data is text data including characters or image data including images is determined. If the print data is text data, the characteristic information of the print data is detected using words of the print data. If the print data is image data, the characteristic information of the print data is detected using colors of the print data.

In operation 310, a determination is made of whether reference characteristic information corresponding to the characteristic information of the print data is stored. If the reference characteristic information is stored, a reproduction message to reproduce multimedia content corresponding to the reference characteristic information is displayed through the image output unit 150 in operation 320.

At least one multimedia content corresponding to at least one reference characteristic information is stored in the storage unit 130. For example, the reference characteristic information can be information corresponding to emotions such as “pleasure,” “disappointment” or “melancholy,” or information corresponding to color representing “intensity” or “cool.” Further, multimedia content corresponding to “pleasure” may be stored as music 1, and multimedia content corresponding to “disappointment” may be stored as music 2. In addition, multimedia content corresponding to “intensity” may be stored as music 2.

Accordingly, when the characteristic information of the print data represents “disappointment”, whether reference characteristic information regarding “disappointment” is stored in the reference characteristic information stored in the storage unit 130 is determined.

FIG. 4A is a view illustrating a multimedia content reproduction message used to select reproduction of music according to the present general inventive concept. As illustrated in FIG. 4A, when multimedia content corresponding to reference characteristic information is music about “spring day,” a reproduction message, (e.g., “Music corresponding to characteristic information of input data is spring day. Reproduce the music?”), is displayed on a predetermined screen display unit.

FIG. 4B is a view illustrating a multimedia content reproduction message used to select reproduction of an image according to the present general inventive concept. As illustrated in FIG. 4B, when multimedia content corresponding to characteristic information of print data is an image about “Picasso's picture,” a reproduction message, (e.g., “An image corresponding to characteristic information of input data is a Picasso's picture. Reproduce the image?”), is displayed.

As a result of the determination in operation 310, if the reference characteristic information corresponding to the characteristic information of the print data is not stored, a message representing that multimedia content cannot be reproduced is displayed on the predetermined screen display unit in operation 330.

That is, when the reference characteristic information corresponding to the characteristic information of the print data is not stored in the storage unit 130, such a message is displayed on the image output unit 150 in order to allow reference characteristic information and multimedia content corresponding to the reference characteristic information to be newly stored.

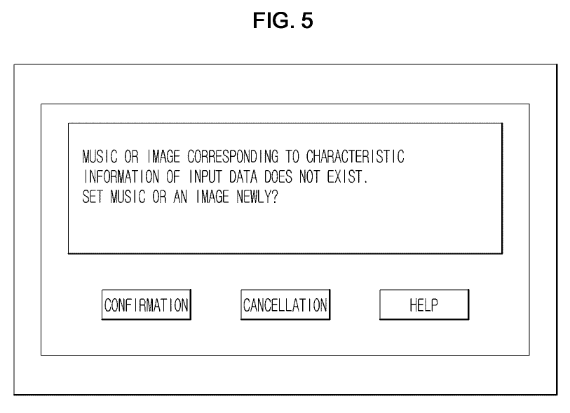

FIG. 5 is a view illustrating the message, which represents that multimedia content cannot be reproduced, according to the present general inventive concept. As illustrated in FIG. 5, a message, (e.g., “music or an image corresponding to characteristic information of input data does not exist. Set music or an image newly ?”), is output such that a user can recognize information representing that music or an image is not reproduced, and reference characteristic information and multimedia content corresponding to the reference characteristic information can be newly stored.

Hereinafter, a method to newly store the reference characteristic information and the multimedia content corresponding to the reference characteristic information will be described. As illustrated in FIG. 5, if a user inputs a selection command such as “confirmation” in order to newly set the multimedia content, a screen to receive the reference characteristic information is displayed. Then, the reference characteristic information is input by the user, and the image forming apparatus 100 accesses a music-related web-site or an image-related web-site through a server 400 to store multimedia content corresponding to the input reference characteristic information. If the user selects desired multimedia content, the server 400 transmits the selected multimedia content to the image forming apparatus 100 such that the transmitted multimedia content can be newly stored as multimedia content corresponding to the reference characteristic information. Herein, the image forming apparatus 100 can automatically access sites frequently visited by the user, or the image forming apparatus 100 can access an address of a site directly input by the user.

Further, multimedia content preset by the user can be automatically reproduced without newly setting the reference characteristic information and the multimedia content corresponding to the reference characteristic information.

Meanwhile, whether a selection command to reproduce the multimedia content is input is determined in operation 340. If the selection command to reproduce the multimedia content is input, the multimedia content corresponding to the characteristic information of the print data is reproduced during a printing process of the print data in operation 350.

That is, whether the selection command (i.e., confirmation) to reproduce the multimedia content is selected from selection commands such as “confirmation,” “cancellation” and “help” displayed on the reproduction message, as illustrated in FIG. 4A, is determined. Accordingly, the multimedia content can be reproduced while the print data is being printed, and the reproduction time of the multimedia content can be properly adjusted according to user setting.

As a result of the determination in operation 340, if the selection command to reproduce the multimedia content is not input, the print data is printed without reproducing the multimedia content in operation 360.

Further, after the message representing that multimedia content cannot be reproduced is displayed on the predetermined screen display unit in operation 330, the print data is printed without reproducing the multimedia content in operation 360.

Hereinafter, the process of controlling the printing system according to the embodiment of FIG. 2 of the present general inventive concept will be described. The terminal apparatus 200 detects characteristic information of print data in operation 300. The process after operation 300 is controlled by the image forming apparatus 100 as described in FIG. 3.

According to the above embodiments, an image forming apparatus, a printing system including the same, and a method of controlling the image forming apparatus and the printing system of the present general inventive concept are included to reproduce multimedia content during a printing process of printing data with reduced electronic noise, so that psychological instability of the user in the modern society due to noise generated from an image forming apparatus and dehumanization represented by electronic products can be reduced.

Further, according to the present general inventive concept, psychological stability is provided to the user, so that various desires of the user can be satisfied.

Although few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. A method of controlling an image forming apparatus, the method comprising:
detecting characteristic information of print data; and
reproducing multimedia content corresponding to the characteristic information of the print data during a printing process of the print data.

2. The method as claimed in claim 1, wherein during the detecting of the characteristic information, the print data is analyzed to determine if the print data is text data or image data.

3. The method as claimed in claim 2, wherein the detecting of the characteristic information comprises:
detecting the characteristic information of the print data using words of the print data if the print data is the text data; and
detecting the characteristic information of the print data using colors of the print data if the print data is the image data.

4. The method as claimed in claim 1, further comprising:
determining if reference characteristic information corresponding to the characteristic information of the print data is stored.

5. The method as claimed in claim 4, wherein the reproducing of the multimedia content includes reproducing the multimedia content corresponding to the reference characteristic information during the printing process if the reference characteristic information corresponding to the characteristic information of the print data is stored.

6. The method as claimed in claim 4, further comprising:
displaying a reproduction message to reproduce the multimedia content, which corresponds to the reference characteristic information, on a predetermined screen display device if the reference characteristic information corresponding to the characteristic information of the print data is stored.

7. The method as claimed in claim 4, further comprising:
displaying a message, which represents that the multimedia content cannot be reproduced, on a predetermined screen display device if the reference characteristic information corresponding to the characteristic information of the print data is not stored.

8. The method as claimed in claim 4, wherein, if the reference characteristic information corresponding to the characteristic information of the print data is not stored, the reference characteristic information and the multimedia content corresponding to the reference characteristic information is searched and stored.

9. The method as claimed in claim 8, wherein the multimedia content is searched after accessing a server connected to the image forming apparatus, such that the multimedia content is stored as the multimedia content corresponding to the reference characteristic information.

10. The method as claimed in claim 4, further comprising:
receiving a selection command to reproduce the multimedia content, such that the multimedia content corresponding to the characteristic information of the print data is reproduced during the printing process of the print data if the selection command to reproduce the multimedia content is received.

11. The method as claimed in claim 1, wherein the multimedia content comprises at least one of sound, an image and text data.

12. An image forming apparatus, comprising:
a control unit to detect characteristic information of print data;
a printing unit to print the print data;
an image output unit to output an image; and
an audio output unit to output sound,
wherein the control unit outputs an image or sound corresponding to the characteristic information of the print data during a printing process of the print data.

13. The image forming apparatus as claimed in claim 12, further comprising:
an input unit to receive a selection command to reproduce the image or sound.

14. The image forming apparatus as claimed in claim 12, further comprising:
a storage unit to store an image or sound corresponding to reference characteristic information.

15. A printing system, comprising:
a terminal apparatus provided with a printer driver to detect characteristic information of print data from words or colors of the print data; and
an image forming apparatus connected to the terminal apparatus through a network to store at least one multimedia content corresponding to characteristic information of at least one print data,
wherein the image forming apparatus reproduces multimedia content corresponding to the characteristic information of the print data, which is transmitted from the terminal apparatus, during a printing process of the print data.

16. The printing system as claimed in claim 15, wherein the printer driver determines if the print data is text data or image data by analyzing the print data.

17. An image forming apparatus, comprising:
a printing unit to print data onto a printing medium;
a storage unit to store multimedia content corresponding to at least one reference characteristic information;
an image output unit to selectively output an image corresponding to the multimedia content; and
an audio output unit to selectively output sound corresponding to the multimedia content.

18. The image forming apparatus of claim 17, wherein the image output unit displays a reproduction message to reproduce multimedia content corresponding to the reference characteristic information when the reference characteristic information is stored.

19. The image forming apparatus of claim 17, further comprising:
an input unit to allow a user to input the reference characteristic information; and
a server to access a web-site to store in the storage unit the multimedia content corresponding to the at least one characteristic information when the reference characteristic information is input by a user.

20. The image forming apparatus of claim 17, wherein the reference characteristic information is information corresponding to human emotions.

21. The image forming apparatus of claim 17, wherein the multimedia content is labeled as a sound or an image corresponding to the reference characteristic information.

22. A method of controlling an image forming apparatus, comprising:
printing data onto a printing medium;
storing multimedia content corresponding to at least one reference characteristic information;
selectively outputting an image corresponding to the multimedia content; and
selectively outputting sound corresponding to the multimedia content.

23. The method of claim 22, further comprising:
accessing a web-site to store in the storage unit the multimedia content corresponding to the at least one characteristic information when the reference characteristic information is input by a user.
